(19) United States
(12) Patent Application Publication
(10) Pub. No.: US 2014/0222445 A1
(43) Pub. Date: Aug. 7, 2014

(54) HEALTH RELATED SOCIAL NETWORKING

(71) Applicant: HEALTHSENSE, INC., (US)

(72) Inventors: Brian J. Bischoff, Red Wing, MN (US); Dean S. Anderson, Cologne, MN (US); Julie A. Bischoff, Red Wing, MN (US)

(73) Assignee: HEALTHSENSE, INC., Mendota Heights, MN (US)

(21) Appl. No.: 13/758,662

(22) Filed: Feb. 4, 2013

(51) Int. Cl. G06Q 50/22; G06Q 10/10

(52) U.S. Cl. CPC G06Q 50/22; G06Q 10/10
USPC 705/2

(57) ABSTRACT

The present disclosure includes method, system, and computer readable medium embodiments to implement a health related social network. One or more embodiments include receiving health information relating to a first user in a health related social network, publishing the received health information to a health page of the first user, and allowing access to the health page of the first user to a second user in the health related social network

### BACKGROUND OF THE DISCLOSURE

Social networking sites (e.g., Internet domains) can provide a platform for people to connect with other people. For instance, a user of a social network can connect with a group of friends, co-workers, classmates, family, and other persons with commonalities. A user can connect with other people, for example, online and remotely from a user device and/or computing device to communicate with one another.

### BRIEF DESCRIPTION OF THE DRAWINGS

FIG. 1 illustrates a block diagram of an example method for health related social networking in accordance with one or more embodiments of the present disclosure.

FIG. 2 illustrates actions of a health related social network system in accordance with one or more embodiments of the present disclosure.

FIG. 3 illustrates a flow diagram of an example process for health related social networking in accordance with one or more embodiments of the present disclosure.

FIG. 4 illustrates a health related social network system in accordance with one or more embodiments of the present disclosure.

### DETAILED DESCRIPTION OF THE DISCLOSURE

Health related social networking methods, systems, and computer-readable mediums are described herein. For example, in one or more embodiments of the present disclosure a method for health related social networking can include receiving health information relating to a first user in a health related social network, publishing the received health information to a health page of the first user, and allowing access to the health page of the first user to a second user in the health related social network.

Social networks can be useful for users to connect with friends, family, and co-workers, among other people the user is an acquaintance with and/or may desire to become an acquaintance. A user can use a social network to communicate personal information to other people (e.g., other users) on the social network and/or in the user's social network. For instance, the information can be communicated to multiple persons by the user doing a single action on the social network. The action can include a post, message, notification, and/or other action on the social network.

A user may desire to communicate personal information, such as health information, to other users in the social network. For example, a user may need assistance due to their health, may have had a health related emergency occur, and/or may desire to communicate a resolution of a health related issue and/or emergency. Such a user can, for example, perform an action to publish health information on the social network to communicate to other users about their health status and/or to assist in receiving further help due to their health status.

In some instances, a user may not desire to communicate the health information to all users in the social network. A social network can include settings for a user to make their page private, for example. A private page can limit access to the page of the user to people whom the user has granted access to the page, sometimes referred to as friends. However, a user may not want to communicate health information to all of their friends on the social network given the personal nature of the health information. The user may, instead, desire that only some friends (e.g., a subset of friends) receive health information.

Further, it can be beneficial in some instances for health information to be communicated in the social network without user action. For instance, a user whom is ill, elderly, and/or otherwise unable to communicate in the social network, may have difficulty performing an action on the social network. As an example, a user with a medical emergency that causes the user to become incapacitated may be unable to perform an action to communicate their health status to family, friends, and other people. The user may wish to communicate a health situation to other users and/or it may be beneficial to communicate the health situation to other users to coordinate a resolution. In addition, if the user is able to communicate personal health information in the social network, the user may not be able to communicate an update of their health status.

Health related social networking, in accordance with one or more embodiments of the present disclosure, can include creating a separate health page and public page for a user. The health page of the user can contain private health information and can be accessible to a subset of friends of the user, for example. Further, in some embodiments, health information can be automatically published to the health page of the user. For instance, an emergency situation, such as missing multiple doses of medication, can be published to the health page of the user without action by the user.

In the following detailed description of the present disclosure, reference is made to the accompanying drawings that form a part hereof, and in which is shown by way of illustration how a number of embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

The figures herein follow a numbering convention in which the first digit or digits correspond to the drawing figure number and the remaining digits identify an element or component in the drawing. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present invention, and should not be taken in a limiting sense.

As used herein, “a number of” something can refer to one or more of such things. For example, a number of persons can refer to one or more persons. As further used herein, the designators, such as “N,”, “P”, “Q”, and “R” particularly with respect to reference numerals in the drawings, indicates that a number of the particular feature so designated can be included with a number of embodiments of the present disclosure.

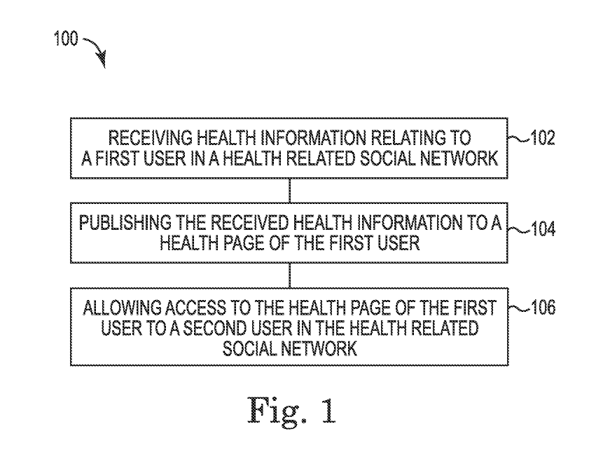

FIG. 1 illustrates a block diagram of an example method 100 for health related social networking in accordance with one or more embodiments of the present disclosure. The method 100 can be used to allow access to a health page of a first user to a subset of users in the health related social network, for example.

At 102, the method 100 can include receiving health information relating to a first user in a health related social network. A social network, as used herein, can include a structure made up of a set of users (e.g., individual users and organizations) and the dyadic ties between the set of users. Each user in the set of users can have a profile on the social network. A user profile on the social network can include one or more domains that provide information relating to a user and people associated with the user. A health related social network can include a social network involving health information of the set of users. For instance, a profile of the first user on a health related social network can be limited to be accessed by a subset of users in the health related social network.

Health information can include information relating to the health of the first user. The health information can be input by the first user, input by a health professional, and/or other personal. For example, health information can include a health status of the first user, measurements of the first user, health related events of the first user, and/or suggestions for the health of the first user from one or more people. For instance, health information can include a medical history, medical information, and/or lifestyle information.

In some embodiments of the present disclosure, the health information can be automatically sent from a sensor system, medical device and/or healthcare file of the first user. A sensor system can include a number of sensors that communicate to each other and/or a computing device. The number of sensors can communicate to each other and/or computing devices by transmitting signals wirelessly. The signals communicated between the number of sensors and/or computing devices can be analyzed and used to monitor and make observations regarding the activities of a first user in a dwelling. In various embodiments, a sensor system can include a number wireless access points that can provide wireless access to a wireless network, such as a Wireless Local Area Network (WLAN), by transferring signals on one or more channels between various components of the wireless network, such as sensors, base stations, and/or computing devices, among other components.

For instance, health information can be sensed by a sensor in the sensor system and automatically sent from the sensor system to the health related social network. The sensed health information can, for example, include a measurement. For example, a sensor system can be part of a monitoring system to monitor the health of the first user. A monitoring system can include the sensor system, one or more medical devices, and/or observations made by healthcare staff.

A medical device can include a kiosk and/or healthcare measurement equipment for making a measurement. A kiosk, as used herein, can be a self-service kiosk that provides healthcare measurement equipment for a person to operate to take healthcare measurements. The kiosk can include a scale, blood pressure monitor, and/or a blood sugar monitor, among other healthcare measurement equipment. The healthcare measurements can be made by a healthcare professional, the first user, and/or many other persons.

A measurement can include a healthcare measurement made by a medical device. The healthcare measurements can be made by healthcare professionals during medical appointments, during visits from healthcare staff to administer treatments, and/or during an evaluation of a first user in a dwelling by the healthcare staff. The healthcare measurements can be made periodically, such as daily, for example. The healthcare measurements can be used to make observations regarding the lifestyle and/or medical conditions of the first user.

A healthcare file, as used herein, can include an electronic file and/or storage containing health information of a first user. The healthcare file, in accordance with one or more embodiments of the present disclosure, can include observations, actions, and outcomes of an adaptive healthcare system that can be sent to and/or received by the health related social network.

An adaptive healthcare system can, for example, include a system of observations, actions, and outcomes of one or more persons that can be used to determine how to adapt healthcare for the one or more persons and/or to determine best healthcare protocols for the one or more persons. Observations, as used herein, can include observations of person from a sensor system, healthcare provider, medical device, and/or feedback from the person. Actions can, for instance, include adjustments to a lifestyle and treatment plan of a person (e.g., first user) based on observations of the person. Outcomes can include changes in lifestyle and/or medical condition of a person based on observations of actions, wherein the actions adjust the lifestyle and treatment plan of the person, for example.

For instance, health information from a healthcare file can include lifestyle information, medical history information, and medical condition information for the first user. Such health information can, for example, include an alarm event, a measurement, and/or a desired outcome of a number of input information (e.g., input by the first user, other user, and healthcare professional). Lifestyle information, as used herein, can include information relating to the environment a person lives in (e.g., type of dwelling, nursing home, and/or hospital), nutrition information (e.g., nutrition requirements and/or limitations), medications used, and/or eating, sleeping, and/or exercise routines, among other aspects of a user's life. The health care file can include information from a sensor system. For example, an alarm event can be detected using the sensor system.

An alarm event can include a health status of a first user that activates, sets-off, and/or causes an alarm. For instance, based on information in a healthcare file (e.g., kiosk and/or medical device measurements, sensor system measurements, and other input information), an alarm can be used to get medical assistance and/or notify others. As an example, an alarm event can occur if a first user misses an important dose of medication, does not get out of bed for 24 hours, and/or measures low oxygen levels, among other events. The healthcare file can include the alarm event, as well as, a determined outcome and/or suggestion based on the alarm event, for example.

At 104, the method 100 can include publishing the received health information to a health page of the first user. A health page of the first user can include a first sub-portion of a profile of the first user on the health related social network, for example. The first sub-portion of the profile of the first user can be associated with health information of the first user. The health information published can include the received health information and/or a subset of the received health information.

In some embodiments of the present disclosure, health information can be published to the health page of the first user based on one or more parameters. For instance, the first user and/or other persons associated with the first user can determine one or more parameters for health information to be published to the health page. As an example, a first user can determine, establish, and/or set one or more parameters to control the amount of health information that is published to the health profile of the first user. Thereby, a first user and/or person associated with the first user can limit the amount of health information that is published to the health related social network.

As an example, a first user may live in a dwelling and not have direct healthcare assistance (e.g., not in a nursing home, assisted living, and/or hospital). In such an instance, it may be beneficial to the first user, family of the first user, and/or healthcare professionals providing healthcare to the first user to have access to all and/or most of the health information received. For example, by publishing all and/or most of the health information to the health page of the first user, the first user may be able to live independently in their dwelling for longer than if the health information were not published because the health status of the first user can be monitored by the first user's family, friends, and/or healthcare professionals.

Alternatively, in some instances, it may be beneficial to the first user, family of the first user, and/or healthcare professionals providing healthcare to the first user to limit the published health information to a subset of the health information received. For instance, a first user and/or other person associated with the first user may not want to publish all of the health information to the health page for privacy reasons and/or to avoid publishing an amount of health information that is over-whelming and/or cumbersome to others. As an example, a first user may determine to not publish daily measurements taken with a medical device unless the measurement results in and/or causes an alarm event.

At 106, the method 100 can include allowing access to the health page of the first user to a second user in the health related social network. For instance, a second user can include a private user. A private user can include a user in the health related social network that the first user has given permission to allow access to the health page. In some embodiments of the present disclosure, the second user can include a plurality of second users. The one or more second users can include a subset of the total users in the health related social network. Allowing access and/or accessing a page of a profile, as used herein, can include allowing access to and/or viewing content of the page.

In some embodiments of the present disclosure, the method 100 can include receiving permission from the first user to allow the second user access to the health page. Permission can be received in response to a request from the second user, independently from the first user, and/or in response to a suggestion from another user (e.g., a private user among the plurality of private users). Permission can, for example, include the first user adding the second user to a health page list and/or private list.

In accordance with various embodiments of the present disclosure, the method 100 can include allowing access to a public page of the first user to the second user and a third user. A public page can, for example, include a second sub-portion of a profile of the first user on the health related social network. The second sub-portion of the profile of the first user can be associated with public information, health information, and/or other information associate with the first user. The first user can, for instance, determine and/or publish various information to the public page as the first user desires.

A third user, as used herein, can include a public user. For instance, a public user can include a person with access to the internet and/or a person that is a member (e.g., a user) of the health related social network. A third user can, for example, have access to the public page but not have access to the health page of the first user.

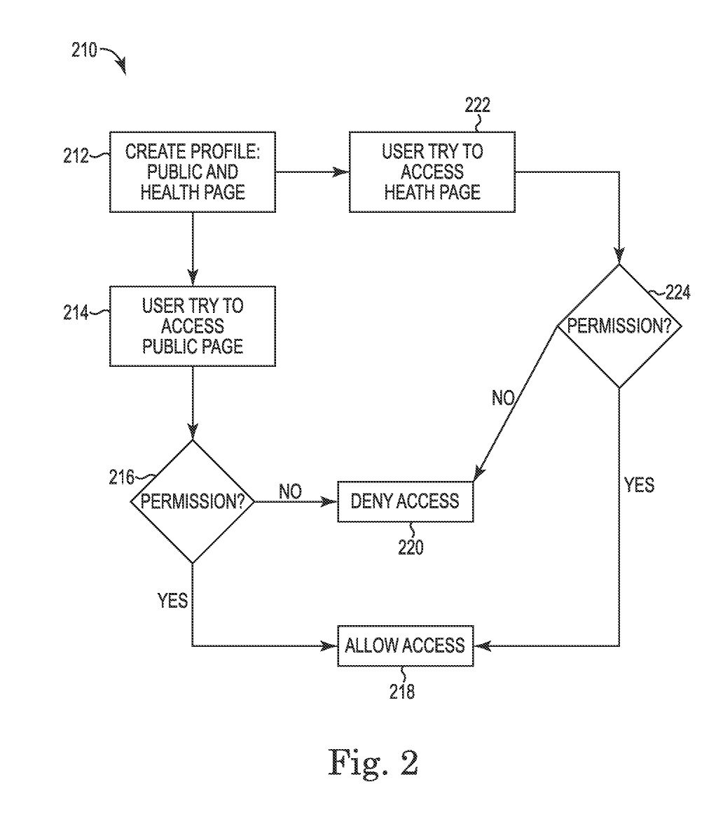

FIG. 2 illustrates actions 210 of a health related social network system in accordance with one or more embodiments of the present disclosure. The actions 210 of the health related social network system can include creating a profile for a first user 212. A profile for a first user can include a public page and a health page, for example. The public page and health page associated with the first user can, for instance, have information that is identical, information that is exclusive to the health page, and/or information that is exclusive to the public page.

In accordance with some embodiments of the present disclosure, a profile for a first user can, for instance, be created by the first user inputting answers to questions and/or filling in boxes. For example, the health page and/or public page of the first user can be formed using a template. A plurality of health pages and/or public pages associated with a plurality of users can, for instance, be formed and/or based on an identical template. Differences between profiles and/or pages of users on the health related social network can be based on questions answered and/or boxes filled in the template by each respective user.

In various embodiments of the present disclosure, the public page and the health page of a first user can include different color schemes (e.g., color differentiation). For example, a health page of a user can include a blue background and a public page can include a white background, among other color schemes. The color differentiation between pages can assist the first user and/or other persons associated with the first user in identifying which page they are on so that health information is not unintentionally and/or accidently published and/or input to the public page when it was intended to be published and/or input to the health page.

At 214, one or more users can attempt to access the public page of the first user. In some instances, the one or more users can include public users. A public user can include a person with access to the internet and/or a person that is a user (e.g., member) of the health related social network 210. For instance, a public user may and/or may not be a friend of the first user.

At 216, in accordance with one or more embodiments of the present disclosure, the health related social network 210 can determine if the one or more users trying to access the public page of the first user have permission to access the public page. Permission to access a public page can include one or more parameters as established, set, and/or indicated by the first user and/or other person associated with the first user.

The parameters can be established, set, and/or indicated, for instance, through the health related social network (e.g., security setting options). For example, permissions to access a public page can include allowing any public user, limiting access to members of the health related social network, and/or limiting access to public users of the health related social network that are friends of the users (e.g., public users added to a list by the user).

In response to determining and/or verifying the one or more users have access, the one or more users can be allowed access and/or granted access to the public page of the first user, at 218. At 220, in response to determining the one or more users do not have permission, the one or more users can be denied access to the public page of the first user. Denying access can, for instance, include a message indicating that the user does not have permission to view the public page of the first user.

Alternatively and/or in addition, one or more users can attempt to access a health page of the first user, at 222. In some instances, the one or more users can include private users. A private user can include a user that is a member of the health related social network and/or has been granted access to the health page of the user.

At 224, the health related social network can determine if the one or more users have permission to access the health page of the first user. Permission to access a health page of the first user can include one or more parameters established, set, and/or indicated by the first user and/or other person associated with the first user. The parameters can be established, set, and/or indicated through the health related social network. For example, permission to access a health page of a first user can include parameters such as a direct indication that a user can access the health page. A direct indication can include adding the user to a private list and/or health page list, accepting a request to be on the list from the user, and/or accepting a request from a third party for a user to be on the list, for example. The private list and/or health page list can, for instance, include a list of private users associated with the first user that can have access to the health page of the first user.

In response to determining and/or verifying the one or more users have access, the one or more users (e.g., private users) can be allowed access and/or granted access to the health page of the first user, at 218. At 220, in response to determining the one or more users do not have permission, the one or more users (e.g., public users and/or non-members of the health related social network) can be denied access to the health page of the first user. Denying access can, for instance, include a message indicating that the user does not have permission to view the health page of the first user.

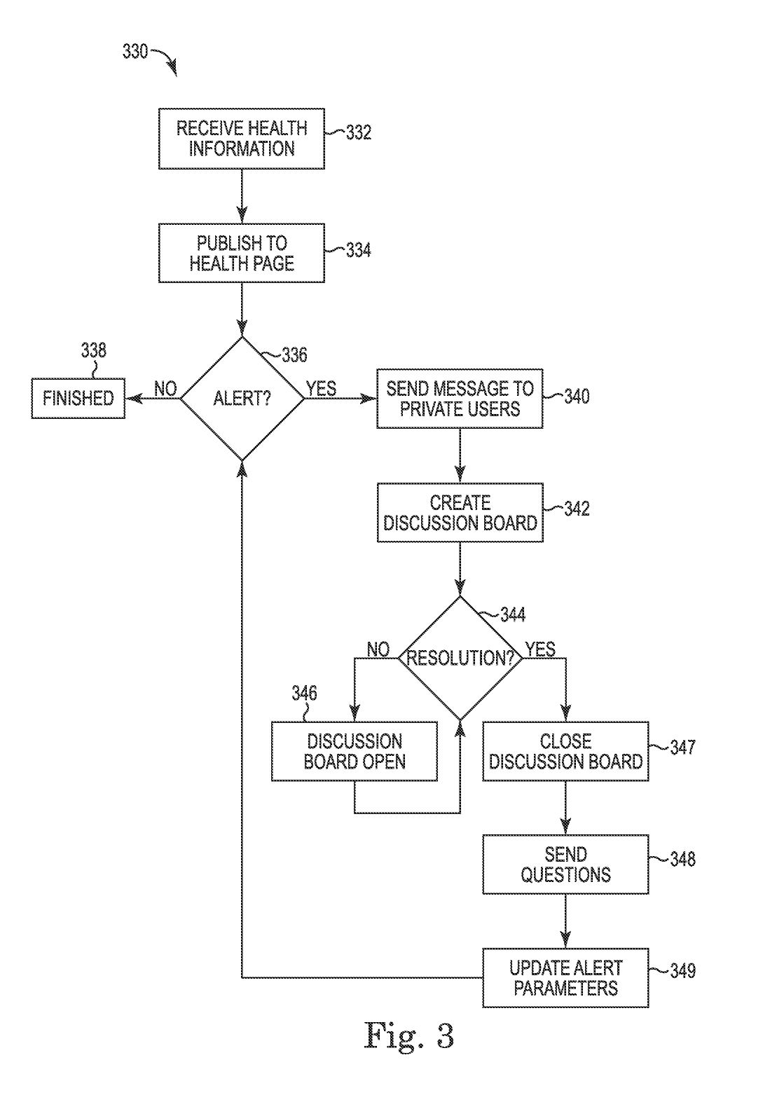

FIG. 3 illustrates a flow diagram of an example process 330 for health related social networking in accordance with one or more embodiments of the present disclosure. The process 330 can be used to monitor and update alarm event parameters used to create a discussion board to resolve a health related issue for a user associated with a health page.

At 332, health information can be received. In accordance with various embodiments of the present disclosure, the health information can be input by the first user and/or other persons associated with the first user, can be automatically received from a sensor system, and/or automatically received from a healthcare file.

At 334, the received health information can be published to the health page. Publishing to the health page can include a post and/or text of the health information added to the health page. The published health information can, in some embodiments, include a subset of the received health information.

In accordance with one or more embodiments of the present disclosure, at 336, a determination can be made as to whether the health information received and/or publish is an alarm event. Determining if an alarm event is received can, for instance, include comparing received health information to one or more parameters (e.g., alarm event parameters). An alarm event parameter can include a rule established and/or set by the first user and/or other person that activates, sets-off, and/or causes an alert and/or a message for an alarm event. If the rule is satisfied, then an alert and/or message can be sent to the one or more private users on the health related social network. If the rule is not satisfied, then no alert and/or message may be sent.

At 338, in response to determining an alarm event has not occurred and/or an alarm event does not activate, set-off, and/or cause an alert and/or message, the process 330 can be finished. At 340, in response to determining an alarm event has occurred, a message can be sent to one or more private users on the health related social network. The message can include an email, a notification, and/or a text message on a cellular telephone associated with a private user, among other messages.

At 342, in response to a determining an alarm event has occurred and/or sending a message, a discussion board can be created. The discussion board can be associated with the health page of the first user and can be accessible through the health page. For instance, the discussion board can include a separate chat room and/or forum for the one or more private users associated with the first user and/or can contain information relating to the alarm event. The one or more private users can enter the discussion board to communicate to one another to resolve and/or discuss the alarm event. For example, when a discussion board is open, the health page of the first user can include a notification of the discussion board. A notification can include a pop-up box, a banner on the health page, and/or a separate icon indicating a discussion board is open, among other notifications.

At 344, a determination can be made as to whether the alarm event has been resolved. For example, an alarm event can be resolved by an indication in the discussion board by one or more private users, the first user, and/or other persons associated with the first user, for example. The indication can include selecting, highlighting, and/or clicking a resolution icon associated with the discussion board, among many other indications.

At 346, in response to determining that the alarm event has not been resolved, the discussion board can remain and/or stay open. A discussion board that remains and/or stays open can include a discussion board that the one or more private users can continue to communicate to one another. At 347, the discussion board can be closed in response to determining the alarm event is resolved. A closed discussion board can, for instance, be archived, saved, and/or stored for future reference.

In response to resolving an alarm event and/or closing a discussion board, at 348, one or more questions can be sent to the first user and/or one or more private users. The questions sent can include questions relating to the alarm event and/or resolution of the alarm event, for instance. For example, the questions can include yes and/or no questions, and/or rating questions (e.g., rate 1 to 5) regarding the first user and/or private user's opinions about the alarm event and/or resolution. The questions can be, for instance, designed to elicit answers to determine if the alarm event parameters of the health page of the first user may need to be changed and/or adjusted.

As an example, questions sent in response to an alarm event for a first user named Bob can include, “Did you and/or someone you know assist Bob in response to receiving an alert from the social network?”, “Was the alert from the social network necessary to assist Bob?”, and/or “Would you like to receive an alert for this same occurrence in the future?” A private user and/or Bob can answer yes or no to each question.

Alternatively, the questions can be formatted to be statements (e.g., you and/or someone you know assisted Bob in response to receiving an alert from the social network). A private user and/or Bob can give a number response, wherein a low number can indicate that statement is true, a high number can indicate that the statement is false, the numbers in between can indicate an answer in the middle of true and/or false, and/or vice versa. Although the present example illustrates three questions, embodiments in accordance with the present disclosure are not so limited and can include additional questions.

At 349, in response to receiving answers to the questions sent to the first user and/or one or more private users, the one or more alarm event parameters can be updated based on the answers received. For instance, the one or more alarm event parameters can be automatically updated and used to determine a future alarm event (e.g., at 336).

In some embodiments of the present disclosure, the answers to the questions can be used as outcomes in an adaptive healthcare system and/or used to adapt a healthcare plan for the first user. For instance, the questions sent can include one or more questions designed to elicit an outcome of the alert for the first user. As an example, such a question can include, “Was Bob admitted to the hospital as a result of the situation that triggered the alarm event?” and/or “Was Bob given medication because of the alarm event?”, among many other questions. Thereby, questions sent to the first user and/or one or more private users can be used for medical treatment and/or diagnosis purposes for the first user in an adaptive healthcare system.

In accordance with some embodiments of the present disclosure, a public user can send invitations and/or messages to the first user using the health related social network. An invitation and/or message can include a notification of an upcoming event of the public user. As an example, a public user can include a nursing home that the first user is interested in joining, is on a waiting list, and/or is looking into. The nursing home can send an invitation, such as for a social event, to the first user so that the first user can become familiar with the staff and/or the people located at the facility.

In various embodiments of the present disclosure, a private user can send reference material to a first user. The reference material can include video, fact sheets, advice, and audio, among many other media forms of reference material. The reference material can, for example, include material related to a health issue the first user may have and/or may be concerned with. For example, the reference material can contain video and/or directions to assist the first user with a health related problem and/or issue. The reference material can, for instance, be published on the health page of the first user.

A private user may, in some instances, publish reference material in response to an indication that the first user has a health issue. As an example, in response to an indication that a first user has been diagnosed with diabetes, a private user can publish and/or send reference material containing a video on cooking meals for those with diabetic needs.

In accordance with one or more embodiments of the present disclosure, the health page of the first user can include a sub-application for one or more user configurable analytical reports. A user configurable analytical report, as used herein, can include a summary report comparing the first user against a similar demographic for a user defined health interest. For example, the analytical report can be created in response to one or more inputs from the first user on the health page of the first user. The one or more inputs from the first user can include the user selecting the sub-application, and indicating an interest in working on a health problem and/or tracking trends of a health interest and/or problem. For example, a health interest can include tracking blood pressure and/or blood sugar concentration, loosing weight, and trends in sleeping habits, among other health interests.

The analytical report can be created by tracking measurements as indicated by the interest of the first user and/or by retrieving (e.g., identifying and/or collecting) medical history information from the healthcare file of the first user. The tracked measurements and/or medical history information can be compared against a similar demographic. A similar demographic can include a statistically similar group of people, such as same sex, age, and geographic location, among other relevant factors. The analytical report can include statistic and trends. The analytical report, in accordance with some embodiments, can be posted on the health page of the first user and can be viewed by the first user and/or the one or more private users (e.g., such as a nurse).

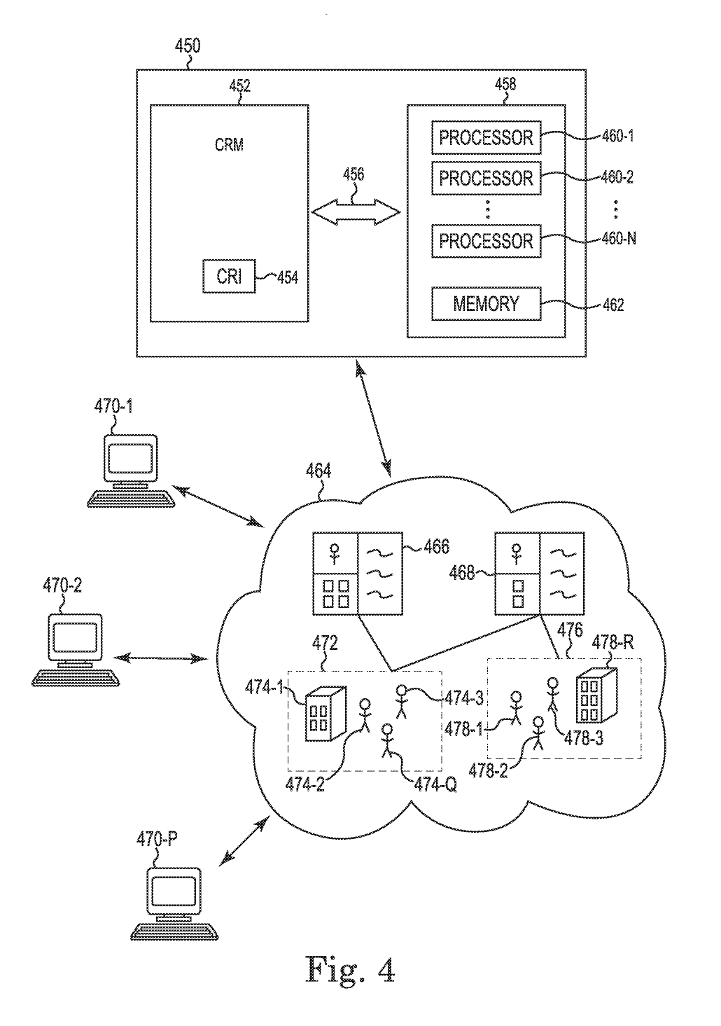

FIG. 4 illustrates a health related social network system in accordance with one or more embodiments of the present disclosure. The health related social network system can include a computing device 450 for implementing a health related social network 464, for example.

The computing device 450, as described herein, can include a computer-readable medium (CRM) 452 in communication with processing resources (e.g., 460-1, 460-2 . . . 460-N). CRM 452 can be in communication with a device 458 having processing resources 460-1, 460-2 . . . 460-N. The device 458 can be in communication with a tangible non-transitory CRM 452 storing a set of computer-readable instructions (CRI) 454 executable by one or more of the processing resources 460-1, 460-2 . . . 460-N, as described herein. The CRI 454 can also be stored in remote memory managed by a server and represent an installation package that can be downloaded, installed, and executed. The device 458 can include memory resources 462, and the processing resources 460-1, 460-2 . . . 460-N can be coupled to the memory resources 462.

Processing resources 460-1, 460-2 . . . 460-N can execute CRI 454 that can be stored on an internal or external non-transitory CRM 452. The processing resources 460-1, 460-2 . . . 460-N can execute CRI 454 to perform various functions, for example, the processing resources 460-1, 460-2 . . . 460-N can execute CRI 454 to collect health information relating to the user from a healthcare file.

A non-transitory CRM (e.g., CRM 452), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 452 can also include distributed storage media. For example, the CRM 452 can be distributed among various locations.

The non-transitory CRM 452 can be integral, or communicatively coupled, to a computing device, in a wired and/or a wireless manner. For example, the non-transitory CRM 452 can be an internal memory, a portable memory, a portable disk, or a memory associated with another computing resource (e.g., enabling CRIs to be transferred and/or executed across a network such as the Internet).

The CRM 452 can be in communication with the processing resources 460-1, 460-2 . . . 460-N via a communication path 456. The communication path 456 can be local or remote to a machine (e.g., a computer) associated with the processing resources 460-1, 460-2 . . . 460-N. Examples of a local communication path 456 can include an electronic bus internal to a machine (e.g., a computer) where the CRM 452 is one of volatile, non-volatile, fixed, and/or removable storage medium in communication with the processing resources 460-1, 460-2 . . . 460-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 456 can be such that the CRM 452 is remote from the processing resources e.g., 460-1, 460-2 . . . 460-N, such as in a network relationship between the CRM 452 and the processing resources (e.g., 460-1, 460-2 . . . 460-N). That is, the communication path 456 can be a network relationship. Examples of such a network relationship can include a local area network (LAN), wide area network (WAN), personal area network (PAN), and the Internet, among others.

In such examples, the CRM 452 can be associated with a first computing device and the processing resources 460-1, 460-2 . . . 460-N can be associated with a second computing device 458 (e.g., a Java server, etc.). For example, a processing resource 460-1, 460-2 . . . 460-N can be in communication with a CRM 452 wherein the CRM 452 includes a set of instructions and wherein the processing resource 460-1, 460-2 . . . 460-N is designed to carry out the set of instructions to collect and publish health information to a health page 466 of the user.

The computing device 450 can be used to implement a health related social network 464. A health related social network 464 can include one or more user profiles. A user profile can include a health page 466 and a public page 468, for example.

As illustrated in the embodiment of FIG. 4, one or more private users 472 can access a health page 466 and a public page 468 of the user (e.g. first user) in the health related social network 464. The one or more private users 472 can include one or more users and/or people 474-2, 474-3, 474-Q of the health related social network 464, and/or one or more organizations and/or associations 474-1 that the user adds to a list and/or gives permission to allow access to the health page 466. An organization and/or association can include a company, a health organization, and a nursing home, among other organizations and/or associations.

One or more public users 476 can, for example, have access to a public page 468 of the user. The one or more public users 476 can include one or more users and/or people 478-1, 478-2, 478-3 of the health related social network 464 and/or one or more organizations and/or associations 478-R that are public users and/or that the user gives permission to allow access to the public page 468. The one or more public users 476, in accordance with embodiments of the present disclosure, may not have access to the health page 466 of the user.

The one or more public users 476, one or more private users 472, and/or the user can access the health related social network 464 including the health page 466 and/or public page 468 of the user using a user computing device 470-1, 470-2 . . . 470-P. The one or more user computing devices 470-1, 470-2 . . . 470-P can, for example, communicate with the health related social network 464 through a network relationship (e.g., Internet).

The processing resources 460-1, 460-2 . . . 460-N coupled to the memory resource 462 of the computing device 450 can allow access to a public page 468 of a user to one or more public users 476 in a health related social network 464 in response to verifying permission from the user, collect health information relating to the user from a healthcare file, publish the health information to a health page 466 of the user, send a message to one or more private users 472 in response to collecting an alarm event relating to the user from the healthcare file, and allow access to the health page 466 of the user to the one or more private users 472 in response to verifying permission from the user. Collecting health information, as used herein, can include communicating to gather, receive, and/or identify health information from a healthcare file, for instance.

In accordance with some embodiments of the present disclosure, the processing resources 460-1, 460-2 . . . 460-N coupled to the memory resource 462 of the computing device 450 can create a directory of available services on the health page 466 of the user. A directory of available services can include one or more organizations, companies, and/or people that provide a service. A service, as used herein, can include a tangible and/or intangible commodity. For example, an intangible commodity can include one or more health related classes (e.g., exercise class and cooking class), health services (e.g., hair salon, massage parlor, and physical therapist), health providers (e.g., local hospitals, doctors, and pharmacies), and/or entertainment services (e.g., restaurants, movie theaters, drama theaters, and sporting events). A tangible commodity can include a good that is offered for sale by one or more organizations, companies, and/or people, for example.

In various embodiments of the present disclosure, the processing resources 460-1, 460-2 . . . 460-N coupled to the memory resource 462 of the computing device 450 can create a health fact sheet for the user in response to inputs from the user and/or other person associated with the user, and allow access to the health fact sheet to the one or more private users 472. A health fact sheet, as used herein, can include vital health information of the user located in a single location. Vital health information can include doctors names and/or locations, vital medical information (e.g., allergies and/or conditions), health insurance information, pharmacy information, and/or other health information that the user and/or person associated with the user indicates is important and/or adds to the health fact sheet. The health fact sheet can be accessible and/or located on the health page 466 of the user, for instance. A private user 472 and/or the user can access the health fact sheet for easy access to the vital health information of the user.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computer-implemented method for health related social networking comprising:
receiving health information relating to a first user in a health related social network;
publishing the received health information to a health page of the first user; and
allowing access to the health page of the first user to a second user in the health related social network.

2. The method of claim 1, wherein the second user includes a plurality of second users.

3. The method of claim 1, the method including automatically receiving health information sensed from a sensor system.

4. The method of claim 1, wherein the health information includes at least one of an alarm event, an input by a user, a measurement, and a determined outcome of a number of input information.

5. The method of claim 1, the method including receiving health information from a healthcare file including lifestyle information, medical history information, and medical condition information for the first user.

6. The method of claim 1, the method including:
allowing access to a public page of the first user to the second user and a third user; and
wherein the third user is not allowed access to the health page of the first user.

7. A non-transitory computer-readable medium storing a set of instructions executable by a processor to cause a computer to:
allow access to a public page of a user to a public user in a health related social network;
receive health information relating to the user;
publish the received health information to a health page of the user; and
allow access to the health page of the user to a private user in the health related social network in response to verifying permission from the user.

8. The medium of claim 7, wherein the instructions are executable to allow access to the public page of the user to the public user in response to verifying permission from the user.

9. The medium of claim 7, wherein the instructions are executable to provide a color differentiation between the public page and the health page of the user.

10. The medium of claim 7, wherein the instructions are executable to send an invitation from the public user to the user in the health related social network.

11. The medium of claim 7, wherein the instructions are executable to publish reference material on the health page of the user.

12. The medium of claim 7, wherein the instructions are executable to create an analytical report for the user in response to inputs from the user.

13. A system for health related social networking, the system comprising a processing resource in communication with a non-transitory computer readable medium, wherein the non-transitory computer readable medium includes a set of instructions and wherein the processing resource is designed to carry out the set of instructions to:
allow access to a public page of a user to a public user in a health related social network in response to verifying permission from the user;
collect health information relating to the user from a healthcare file;
publish the health information to a health page of the user;
send a message to a private user in response to collecting an alarm event relating to the user from the healthcare file; and
allow access to the health page of the user to the private user in the health related social network in response to the verifying permission from the user.

14. The system of claim 13, wherein the processing resource is designed to carry out the set of instructions to create a discussion board on the health page of the user, in response to collecting the alarm event.

15. The system of claim 14, wherein the processing resource is designed to carry out the set of instructions to close the discussion board on the health page of the user, in response to an indication that the alarm event is resolved.

16. The system of claim 13, wherein the processing resource is designed to carry out the set of instructions to receive a number of parameters for the alarm event.

17. The system of claim 13, wherein the processing resource is designed to carry out the set of instructions to send a number of questions to the user and the private user, in response to an indication that the alarm event is resolved.

18. The system of claim 17, wherein the processing resource is designed to carry out the set of instructions to automatically update a number of parameters for a future alarm event based on a number of received answers to the number of questions sent.

19. The system of claim 13, wherein the processing resource is designed to carry out the set instructions to create a directory of available services on the health page of the user.

20. The system of claim 15, wherein the processing resource is designed to carry out the set of instructions to:
create a health fact sheet for the user in response to inputs from the user; and
allow access to the health fact sheet to the private user.
